(19) United States
(12) Patent Application Publication
(10) Pub. No.: US 2006/0184299 A1
(43) Pub. Date: Aug. 17, 2006

(54) SYSTEM FOR DETERMINING ROLLOVER IN A VEHICLE CONTROL SYSTEM

(75) Inventors: Fubang Wu, Rochester Hills, MI (US); Cliff Chou, Farmington Hills, MI (US); Jianbo Lu, Livonia, MI (US); Joseph C. Meyers, Farmington Hills, MI (US)

Correspondence Address: ARTZ & ARTZ, P.C., 28333 TELEGRAPH ROAD, SUITE 250, SOUTHFIELD, MI, 48034, US

(73) Assignee: Ford Global Technologies, LLC, Dearborn, MI (US)

(21) Appl. No.: 10/906,264

(22) Filed: Feb. 11, 2005

(51) Int. Cl. B60G 17/005

(52) U.S. Cl. 701/45; 280/5.502

(57) ABSTRACT

A control system (18) and method for an automotive vehicle (10) is provided in which various dynamic control system sensors are monitored and used to activate a dynamic control system which is indicative of a vehicle instability. Vehicle instability may also be determined using an energy threshold. Once vehicle instability is determined, a roll trend is determined in response thereto. The roll trend may use an accumulative directional indicator to determine whether the trend of the vehicle is toward rolling over. If the vehicle is tending to roll over, a safety device such as an airbag may be deployed.

### TECHNICAL FIELD

The present invention relates generally to a control apparatus for controlling a safety system of an automotive vehicle in response to sensed rollover, and more specifically, to a method and apparatus for determining rollover.

### BACKGROUND

Occupant restraint systems and, in particular, inflatable occupant restraint systems, are increasingly being used in automotive vehicles. Nearly every vehicle now produced has driver and passenger front airbags. Side airbags are also increasingly being used in automotive vehicles. Side airbags use lateral acceleration sensors to detect the lateral acceleration of the vehicle and thus the presence of a side impact. In response to lateral acceleration, the side airbags are deployed in side impacts.

Another newer type of inflatable occupant restraint system is a side curtain airbag. The side curtain airbag deploys from the ceiling or near the roof header and extends downward in front of the side windows of the vehicle. This system is designed to protect occupants in rollover conditions.

Another type of non-inflatable system is a pretensioner system coupled to the seatbelt. A pretensioner system reduces the amount of spool-out in the seatbelts upon a sensed condition.

Each of the above systems may potentially be employed during rollover of a vehicle. Commonly, an energy-based model is used to determine when rollover occurs.

Dynamic control systems such as yaw stability control systems and roll stability control systems have been to control vehicle dynamics. Vehicle roll stability control (RSC) schemes, i.e., U.S. Pat. No. 6,324,446, have been proposed to address the issue of friction-induced rollovers. RSC system includes a variety of sensors sensing vehicle states and a controller that controls a distributed brake pressure to reduce a tire force so the net moment of the vehicle is counter to the roll direction.

During an event causing the vehicle to roll, the vehicle body is subject to a roll moment due to the coupling of the lateral tire force and the lateral acceleration applied to the center of gravity of vehicle body. This roll moment causes suspension height variation, which in turn results in a vehicle relative roll angle (also called chassis roll angle or suspension roll angle). The relative roll angle is an important variable that is used as an input to the activation criteria and to construct the feedback pressure command, since it captures the relative roll between the vehicle body and the axle. The sum of the chassis roll angle and the roll angle between wheel axle and the road surface (called wheel departure angle) provides the roll angle between the vehicle body and the average road surface, which is one of the important variables feeding back to the roll stability control module.

Vehicle dynamic control systems such as roll control systems and occupant restraint devices are independent systems, thus not working together. Roll stability control systems may ultimately prevent the vehicle from rolling over even though the energy rate threshold has been reached or exceeded. It would therefore be desirable to provide a system for activating an occupant restraint that utilizes the information available from a dynamic control system in the determination for the activation of the occupant restraint.

### SUMMARY OF THE INVENTION

The present invention takes into consideration a vehicle instability control signal that may be generated from the activation of a roll stability control system or other dynamic control system and/or an energy threshold.

In one aspect of the invention, a method of operating a vehicle having a safety device includes generating a vehicle instability signal indicative of an unstable vehicle in response to the vehicle instability signal, generating an accumulative directional indicator. The method further includes a step of activating the safety device when the accumulative directional indicator and the vehicle instability signal are indicative of a rollover condition.

In a further aspect of the invention, a method of operating a safety device includes sensing a plurality of dynamic conditions of the vehicle, activating a dynamic control system in response to at least some of the plurality of dynamic conditions and generating a dynamic control system status signal in response to activating. After the step of generating a dynamic control system status signal a rollover trend is determined in response to the roll rate signal. The safety device is activated when the roll trend is indicative of a rollover condition in the dynamic control system status signal.

One advantage of the invention is that the presence of an uncorrectable rollover is determined and activation of a device is prevented during a correctable rollover condition.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a diagrammatic view of a vehicle with coordinate frames according to the present invention.

FIG. 2 is a block diagram of a stability system according to the present invention.

FIG. 3 is a front view of an automotive vehicle illustrating various angles according to the present invention.

FIG. 4 is a top view of an automotive vehicle having variables used in the following calculations thereon.

FIG. 5 is a block diagrammatic view of an algorithm for operating the device according to the present invention.

FIG. 6 is a block diagrammatic view for the determination of the change in roll rate.

FIGS. 7A and 7B illustrate an energy threshold used for determining vehicle instability according to the present invention.

FIGS. 8A-8H illustrate various vehicle parameters versus time during a fish hook turn.

FIG. 9A-9H illustrate various vehicle parameters determined during a J-turn.

FIG. 10 is a high level flowchart illustrating a method for operating the present invention.

### DETAILED DESCRIPTION

In the following figures, the same reference numerals will be used to identify the same components. The present invention may be used in conjunction with a rollover control system or other dynamic control systems for a vehicle. The present invention may also be used with a deployment device such as airbag or active roll bar or pre-tensioning belts. The present invention will be discussed below in terms of preferred embodiments relating to an automotive vehicle moving in a three-dimensional road terrain.

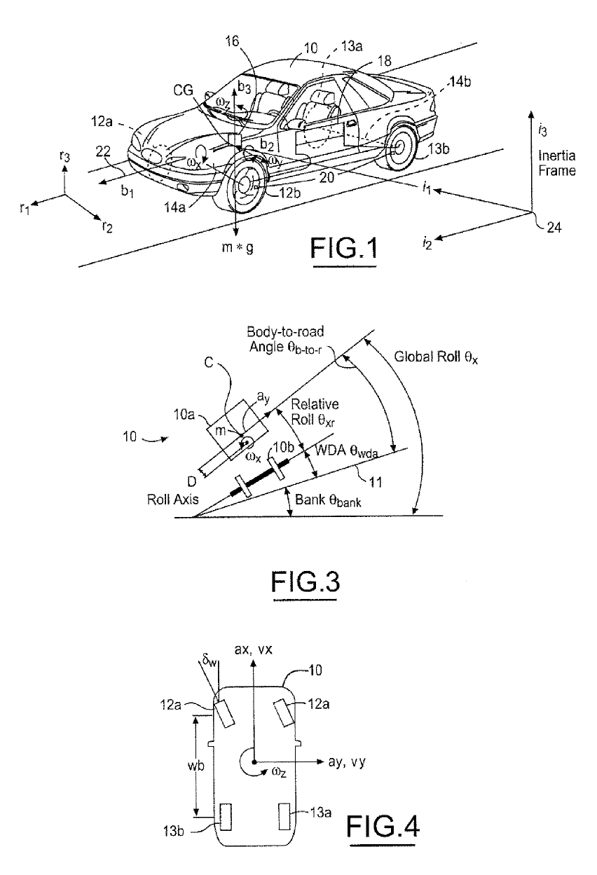

Referring to FIG. 1, an automotive vehicle 10 with a safety system of the present invention is illustrated with the various forces and moments thereon during a dynamic condition. Vehicle 10 has front right (FR) and front left (FL) wheel/tires 12A and 12B and rear right (RR) wheel/tires 13A and rear left (RL) wheel/tires 13B, respectively. The vehicle 10 may also have a number of different types of front steering systems 14a and rear steering systems 14b, including having each of the front and rear wheels configured with a respective controllable actuator, the front and rear wheels having a conventional type system in which both of the front wheels are controlled together and both of the rear wheels are controlled together, a system having conventional front steering and independently controllable rear steering for each of the wheels, or vice versa. Generally, the vehicle has a weight represented as M*g at the center of gravity of the vehicle, where g=9.8 m/s² and m the total mass of the vehicle.

As mentioned above, the system may also be used with safety systems including active/semi-active suspension systems, anti-roll bar, or airbags or other safety devices deployed or activated upon sensing predetermined dynamic conditions of the vehicle.

The sensing system 16 is coupled to a control system 18. The sensing system 16 may comprise many different sensors including the sensor set typically found in a roll stability control or a rollover control system (including lateral accelerometer, yaw rate sensor, steering angle sensor and wheel speed sensor which are equipped for a traditional yaw stability control system) together with a roll rate sensor and a longitudinal accelerometer. The various sensors will be further described below. The sensors may also be used by the control system in various determinations such as to determine a lifting event. The wheel speed sensors 20 are mounted at each corner of the vehicle and generate signals corresponding to the rotational speed of each wheel. The rest of the sensors of sensing system 16 may be mounted directly on the center of gravity of the vehicle body, along the directions x, y and z shown in FIG. 1. As those skilled in the art will recognize, the frame from b₁, b₂ and b₃ is called a body frame 22, whose origin is located at the center of gravity of the car body, with the b₁ corresponding to the x axis pointing forward, b₂ corresponding to the y axis pointing off the driving side (to the left), and the b₃ corresponding to the z axis pointing upward. The angular rates of the car body are denoted about their respective axes as ωₓ for the roll rate, ωₓ for the pitch rate and ω_{z} for the yaw rate. Calculations may take place in an inertial frame 24 that may be derived from the body frame 22 as described below.

The angular rate sensors and the accelerometers may be mounted on the vehicle car body along the body frame directions b₁, b₂ and b₃ which are the x-y-z axes of the sprung mass of the vehicle.

The longitudinal acceleration sensor is mounted on the car body located at the center of gravity, with its sensing direction along b₁-axis, whose output is denoted as aₓ. The lateral acceleration sensor is mounted on the car body located at the center of gravity, with its sensing direction along b₂-axis, whose output is denoted as a_{Y}.

The other frame used in the following discussion includes the road frame, as depicted in FIG. 1. The road frame system r₁r₂r₃ is fixed on the driven road surface, where the r₃ axis is along the average road normal direction computed from the normal directions of the four-tire/road contact patches.

In the following discussion, the Euler angles of the body frame b₁b₂b₃ with respect to the road frame r₁r₂r₃ are denoted as θ_{xbr} and θ_{ybr}, which are also called the relative Euler angles (i.e., relative roll and relative pitch angles, respectively).

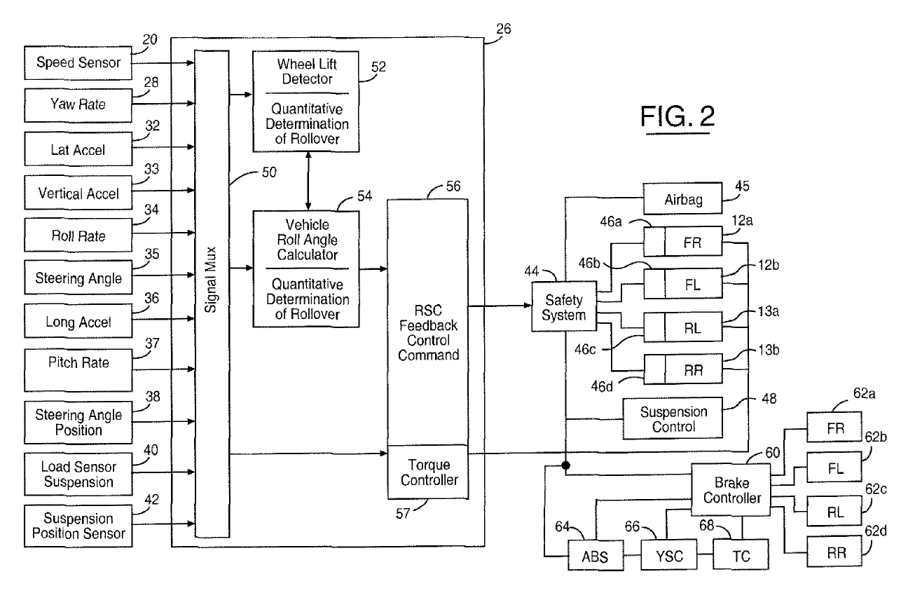

Referring now to FIG. 2, roll stability control system 18 is illustrated in further detail having a controller 26 used for receiving information from a number of sensors which may include a yaw rate sensor 28, a speed sensor 20, a lateral acceleration sensor 32, a vertical accelerometer sensor 33, a roll angular rate sensor 34, a steering wheel (hand wheel) angle sensor 35, a longitudinal acceleration sensor 36, a pitch rate sensor 37, steering angle (of the wheels or actuator) position sensor 38, suspension load sensor 40 and suspension position sensor 42. It should be noted that various combinations and sub-combinations of the sensors may be used.

Speed sensor 20 may be one of a variety of speed sensors known to those skilled in the art. For example, a suitable speed sensor may include a sensor at every wheel that is averaged by controller 26. The controller 26 may translate the wheel speeds into the speed of the vehicle. Yaw rate, steering angle, wheel speed and possibly a slip angle estimate at each wheel may be translated back to the speed of the vehicle at the center of gravity. Various other algorithms are known to those skilled in the art. Speed may also be obtained from a transmission sensor. For example, if speed is determined while speeding up or braking around a corner, the lowest or highest wheel speed may not be used because of its error. Also, a transmission sensor may be used to determine vehicle speed.

By identifying wheel lift, a roll condition, a yaw condition, activation of the roll stability control system, activation of a yaw control system, a determination as to the vehicle stability and the generation of a vehicle instability signal may be generated.

Roll angular rate sensor 34 and pitch rate sensor 37 may sense the roll condition or lifting of the vehicle based on sensing the height of one or more points on the vehicle relative to the road surface. Sensors that may be used to achieve this include but are not limited to a radar-based proximity sensor, a laser-based proximity sensor and a sonar-based proximity sensor. The roll rate sensor 34 may also use a combination of sensors such as proximity sensors to make a roll rate determination.

Roll rate sensor 34 and pitch rate sensor 37 may also sense the roll condition or lifting based on sensing the linear or rotational relative displacement or velocity of one or more of the suspension chassis components. This may be in addition to or in combination with suspension position sensor 42. The position sensor 42, roll rate sensor 34 and/or the pitch rate sensor 37 may include a linear height or travel sensor, a rotary height or travel sensor, a wheel speed sensor used to look for a change in velocity, a steering wheel position sensor, a steering wheel velocity sensor and a driver heading command input from an electronic component that may include steer by wire using a hand wheel or joy stick.

The roll condition or lifting may also be sensed by sensing directly or estimating the force or torque associated with the loading condition of one or more suspension or chassis components including a pressure transducer in an act of air suspension, a shock absorber sensor such as a load sensor 40, a strain gauge, the steering system absolute or relative motor load, the steering system pressure of the hydraulic lines, a tire laterally force sensor or sensors, a longitudinal tire force sensor, a vertical tire force sensor or a tire sidewall torsion sensor. The yaw rate sensor 28, the roll rate sensor 34, the lateral acceleration sensor 32, and the longitudinal acceleration sensor 36 may be used together to determine that the wheel has lifted. Such sensors may be used to determine wheel lift or estimate normal loading associated with wheel lift. These are passive methods as well.

The roll condition of the vehicle may also be established by one or more of the following translational or rotational positions, velocities or accelerations of the vehicle including a roll gyro, the roll rate sensor 34, the yaw rate sensor 28, the lateral acceleration sensor 32, the vertical acceleration sensor 33, a vehicle longitudinal acceleration sensor 36, lateral or vertical speed sensor including a wheel-based speed sensor 20, a radar-based speed sensor, a sonar-based speed sensor, a laser-based speed sensor or an optical-based speed sensor.

In the preferred embodiment, the sensors are located at the center of gravity of the vehicle. Those skilled in the art will recognize that the sensor may also be located off the center of gravity and translated equivalently thereto.

Lateral acceleration, roll orientation and speed may be obtained using a global positioning system (GPS). Based upon inputs from the sensors, controller 26 may control a safety device 44. Depending on the desired sensitivity of the system and various other factors, not all the sensors 28-42 may be used in a commercial embodiment.

Load sensor 40 may be a load cell coupled to one or more suspension components. By measuring the stress, strain or weight on the load sensor a shifting of the load can be determined.

Controller 26 may include a signal multiplexer 50 that is used to receive the signals from the sensors 20 and 28-42. The signal multiplexer 50 provides the signals to a wheel lift detector 52, a vehicle roll angle calculator 54, and to a roll stability control (RSC) feedback control command 56. Also, wheel lift detector 52 may be coupled to the vehicle roll angle calculator 54. The vehicle roll angle calculator 54 may also be coupled to the RSC feedback command 56. The RSC feedback command 56 may include a torque controller 57. Vehicle roll angle calculator 54 is described in U.S. Provisional Applications 60/400,376 and 60/400,172, and in U.S. patent application Ser. No. 10/459,697, the disclosures of which are incorporated herein by reference.

Safety device 44 may control an airbag 45 or a steering actuator 46a-46d at one or more of the wheels 12a, 12b, 13a, 13b of the vehicle. Also, other vehicle components such as a suspension control 48 may be used to adjust the suspension to prevent rollover.

Safety device 44 may control the position of the front right wheel actuator 46a, the front left wheel actuator 46b, the rear left wheel actuator 46c, and the right rear wheel actuator 46d. Although as described above, two or more of the actuators may be simultaneously controlled. For example, in a rack-and-pinion system, the two wheels coupled thereto are simultaneously controlled. Based on the inputs from sensors 20 and 28 through 42, controller 26 determines a roll condition and/or wheel lift and controls the steering position, braking of the wheels and/or activation of a safety device.

Safety device 44 may be coupled to a brake controller 60. Brake controller 60 controls the amount of brake torque at a front right brake 62a, front left brake 62b, rear left brake 62c and a rear right brake 62d.

The roll condition of a vehicle can be characterized by rolling radius-based wheel departure roll angle, which captures the angle between the wheel axle and the average road surface through the dynamic rolling radii of the left and right wheels when both of the wheels are grounded. Since the computation of the rolling radius is related to the wheel speed and the linear velocity of the wheel, such rolling-radius based wheel departure angle will assume abnormal values when there are large wheel slips. This happens when a wheel is lifted and there is torque applied to the wheel. Therefore, if this rolling radius-based wheel departure angle is increasing rapidly, the vehicle might have lifted wheels. Small magnitude of this angle indicates the wheels are all grounded.

The roll condition of the vehicle can be seen indirectly from the wheel longitudinal slip. If during a normal braking or driving torque the wheels at one side of the vehicle experience increased magnitude of slip, then the wheels of that side are losing longitudinal road torque. This implies that the wheels are either driven on a low mu surface or lifted up. The low mu surface condition and wheel-lifted-up condition can be further differentiated based on the chassis roll angle computation, i.e., in low mu surface, the chassis roll angle is usually very small. Hence, an accurate determination of chassis roll is desired.

The roll condition of the vehicle can be characterized by the normal loading sustained at each wheel. Theoretically, when a normal loading at a wheel decreases to zero, the wheel is no longer contacting the road surface. In this case a potential rollover is underway. Large magnitude of this loading indicates that the wheel is grounded. Normal loading is a function of the calculated chassis roll and pitch angles. Hence, an accurate determination of chassis roll and pitch angles is desired.

The roll condition can be identified by checking the actual road torques applied to the wheels and the road torques, which are needed to sustain the wheels when they are grounded. The actual road torques can be obtained through torque balancing for each wheel using wheel acceleration, driving torque and braking torque. If the wheel is contacting the road surface, the calculated actual road torques must match or be larger than the torques determined from the nonlinear torques calculated from the normal loading and the longitudinal slip at each wheel.

The roll condition of a vehicle can be characterized by the chassis roll angle itself, i.e., the relative roll angle θₓᵣ between the vehicle body and the wheel axle. If this chassis roll angle is increasing rapidly, the vehicle might be on the edge of wheel lifting or rollover. Small magnitude of this angle indicates the wheels are not lifted or are all grounded. Hence, an accurate determination of the chassis roll angle is beneficial for determining if the vehicle is in non-rollover events.

The roll condition of a vehicle can also be characterized by the roll angle between the wheel axle and the average road surface, this is called wheel departure angle. If the roll angle is increasing rapidly, the vehicle has lifted wheel or wheels and aggressive control action needs to be taken in order to prevent the vehicle from rolling over. Small magnitude of this angle indicates the wheels are not lifted.

The center of gravity C is also illustrated with nominal mass m. A roll axis is also illustrated at a distance D from the center of gravity. a_{y} is the lateral acceleration.

Referring now to FIG. 3, the relationship of the various angles of the vehicle 10 relative to the road surface 11 is illustrated. In the following, a reference road bank angle θ_{bank} is shown relative to the vehicle 10 on a road surface. The vehicle has a vehicle body 10a and wheel axle 10b. The wheel departure angle θ_{wda} is the angle between the wheel axle and the road. The relative roll angle θₓᵣ is the angle between the wheel axle 10b and the body 10a. The global roll angle θₓ is the angle between the horizontal plane (e.g., at sea level) and the vehicle body 10a.

Another angle of importance is the linear bank angle. The linear bank angle is a bank angle that is calculated more frequently (perhaps in every loop) by subtracting the relative roll angle generated from a linear roll dynamics of a vehicle (see U.S. Pat. No. 6,556,908 which is incorporated by reference herein), from the calculated global roll and pitch angles (as the one in U.S. patent application Ser. No. 09/789,656, which is incorporated by reference herein). If all things were slowly changing without drifts, errors or the like, the linear bank angle and reference road bank angle terms would be equivalent.

Referring now to FIG. 4, an automotive vehicle 10 is illustrated with various parameters illustrated thereon. The longitudinal acceleration is denoted by ax whereas the longitudinal velocity is denoted vₓ. The lateral acceleration and lateral velocity is denoted by a_{y},v_{y}, respectively. The steering wheel angle is denoted by δ_{w}. The wheelbase of the vehicle is denoted by the symbol wb.

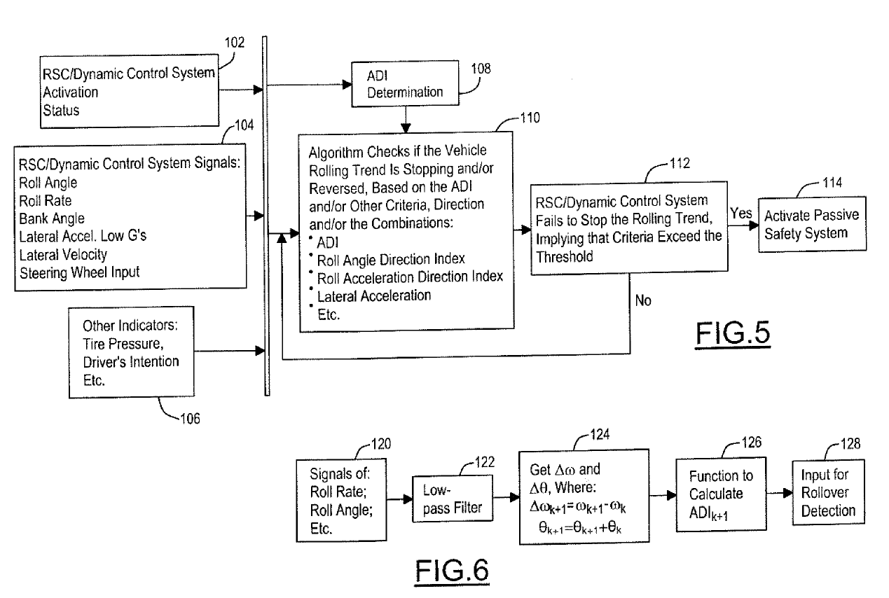

Referring now to FIG. 5, an algorithm flow chart for the controller 26 (shown in FIG. 2) is illustrated below. It should be noted that the controller 26 may be part of the roll stability control system, the safety device, a central controller or a distribution between the combination of various controllers including a dynamic controller and a safety device controller. In block 102, the activation status may be one input to the system. The activation status may come from the roll stability control system or a dynamic control system such as a yaw stability control system. In step 104, the various signals from the roll stability control system or the dynamic control system such as the roll angle, roll rate, bank angle, lateral acceleration, lateral velocity, and steering wheel input may also be provided to the system. Other indicators 106 may also be provided to the vehicle system such as the driver's intention and the tire pressure. As will be further described below, an accumulative direction indicator (ADI) determination 108 may use the various signals as described below to determine an accumulative direction indicator. The accumulative direction indicator is a reflection of the vehicle rollover trend. This trend may be shown as an increase/decrease of the roll angle and/or the roll rate. Further derivation of this is illustrated in FIG. 6 below. In block 110, the algorithm checks if the vehicle rolling trend is stopping and/or reversed based on the accumulative direction indicator and/or other criteria, direction and/or the various combinations thereof. Various inputs may include the ADI, the roll angle direction index, roll acceleration direction index, lateral acceleration, etc. The output of block 110 is provided to block 112. In this block it is determined whether or not the roll stability control system or other dynamic control system fails to stop the rolling trend which implies that the criteria exceed the threshold. If the rolling trend ceases, block 110 is again executed. In step 112, if the rolling trend has not stopped a deployable device is activated in step 114. Various types of activations may take place including side curtain airbags, side impact airbags, and seatbelt pretensioners. External airbags may also be deployed.

Referring now to FIG. 6, the ADI determination block 108 above is described in further detail. The ADI may take into consideration the roll rate and/or the roll angle. Other signals may also be taken into consideration. These signals are illustrated in block 120. The signals may be low pass filtered in block 122 to filter out various noise associated with the system. The accumulative directional indicator (ADI) may be as simple as Δω or Δθ or combination of Δω or Δθ. The Δωaccumulates over time. That is, in step 124 a formula for a cumulative determination over time takes into consideration a previous roll rate and a current roll rate which is summed together. That is, the previous roll angle ωₖ is subtracted from the current roll rate ωₖ₊₁. Similarly, in step 124, a formula for a cumulative determination over time takes into consideration a previous roll angle and a current roll angle which is summed together. That is, the previous roll angle θₖ is subtracted from the current roll angle θₖ₊₁. The model expression of the ADI may be written as
ADI=k1ΣΔω+k2ΣΔθ,
where k1 and k2 are weighting factors for the roll rate and the roll angle. The roll rate is w and the roll angle is θ. In an implementation, the change in roll rate Δω and/or the change in roll angle Δθ term will be monitored for a certain time (5 msec to 100 msec). This is expressed using the Σ in the above equation. When the roll trend is continuing, which means the ADI is positive or non-negative, passive rollover protection system may be needed. In a digital implementation, the above formula may be set forth as ADIₖ₊₁=ADIₖ+k1Δωₖ₊₁+k2Δθₖ₊₁. Such an implementation is illustrated in block 126. The ADI provides an input to the rollover detection block 110 illustrated in FIG. 6 as block 128. Thus, as will be illustrated below, the system uses the accumulative direction indicator and the activation status of the dynamic control system for determining whether deployment of an airbag is required. An instability signal is provided by the dynamic control system or roll stability control system for initiating the further checks of the system.

The gains k1 and k2 may be determined experimentally during testing of the vehicle. A chart or table may be used to adjust the gains based on various vehicle conditions. These conditions may be performed on the test track and may be set for each individual type of vehicle based on the current operating conditions. For example, the gains may change based upon the vehicle forward speed, the yaw rate, the slip angle of the vehicle, the lateral acceleration, and the steering wheel input of the vehicle. Thresholds may be set for the yaw rate, slip rate, forward speed, roll angle/rate to allow the gains k1 and k2 to change.

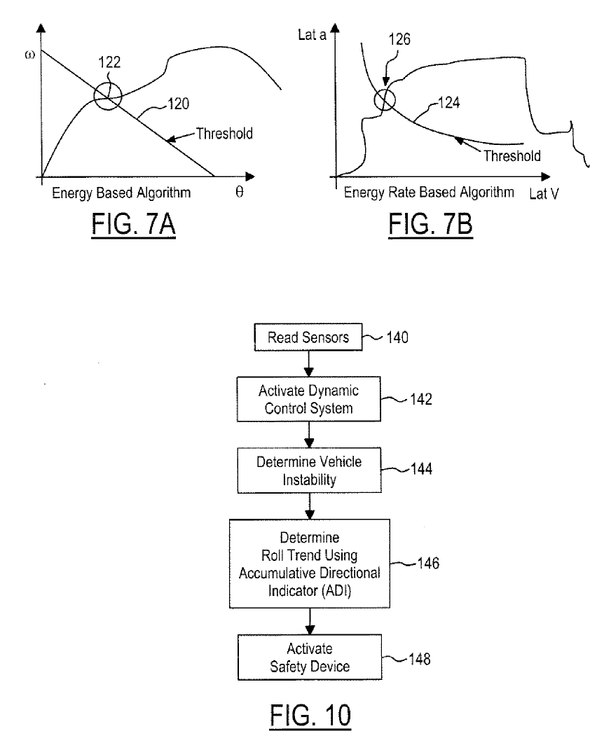

Referring now to FIGS. 7A and 7B, should a vehicle not include a dynamic control system such as a roll stability control system, a vehicle instability signal may be generated in various ways. For example, in FIG. 7A a comparison between the roll rate and the roll angle may be performed. When comparing the roll rate versus roll angle, if an energy threshold 120 is crossed such as at point 122, the further checks of the system and the roll trend may be determined. In FIG. 7B, the lateral acceleration versus the lateral velocity is illustrated. This also provides an energy threshold 124. Should the lateral acceleration and lateral velocity of the vehicle cross the acceleration threshold 124 such as at point 126, the accumulative direction indicator may be generated in response thereto. It should be noted that in prior systems the energy threshold was the only threshold determined. In the present application, the energy rate threshold is the initial or starting point of the system. As was mentioned above, just because an energy rate threshold is crossed still does not guarantee a rollover will be happening. Thus, the rollover decision in either case with or without a dynamic control system is made in response to a roll trend or the accumulative direction indicator whose calculation is initiated at a vehicle instability signal from the dynamic control system or the determination of a crossing of an energy threshold. The accumulative direction indicator illustrates the trending of the vehicle to roll over.

The energy threshold may be used to determine a roll trend. Also, other variables may be compared to a threshold to determine a roll trend. A combination of comparisons may also be used. For example, comparing lateral velocity, forward velocity, roll rate, roll angle, and yaw rate to respective thresholds may be performed. The thresholds are set during vehicle testing and development.

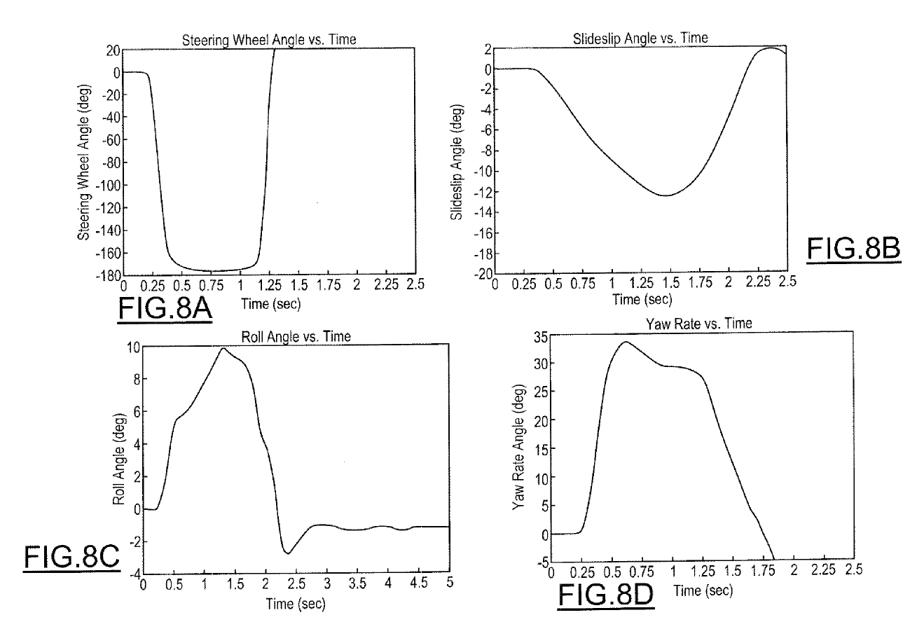

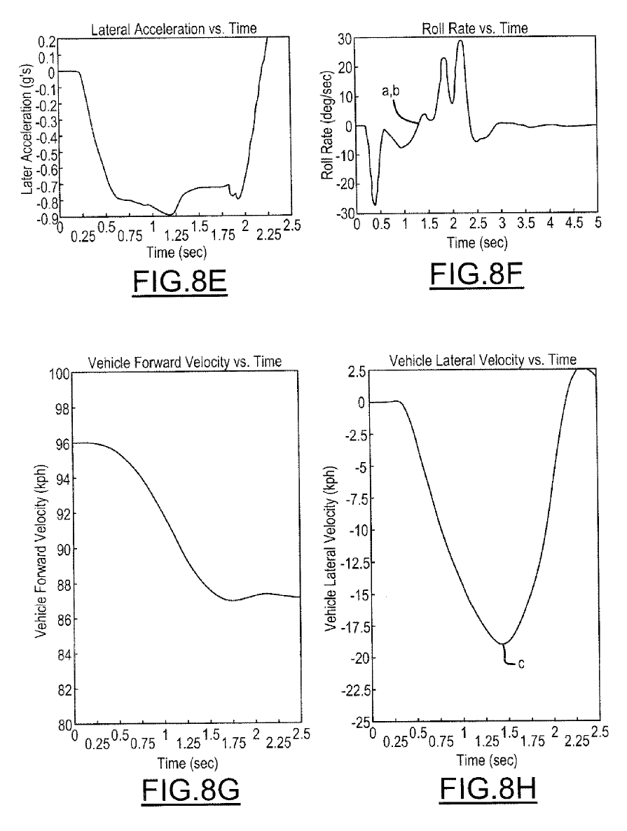

Referring now to FIG. 8A, in the case of a dynamic control system, the roll determination allows the vehicle stability system to overcome the rolling trend before deployment of an airbag or other deployable device.

Referring now to FIGS. 8A-8H, an illustration of a vehicle in a fish hook event where the steering wheel is turned in one direction and the opposite direction is illustrated. FIG. 8A shows the steering wheel angle versus time. As can be seen, a reversal in the steering wheel angle is illustrated. In FIG. 8B, the side slip angle versus time is illustrated. In FIG. 8C, roll angle versus time is illustrated. In FIG. 8D, yaw rate versus time is illustrated. In FIG. 8E, lateral acceleration versus time is illustrated. In FIG. 8F, points a and b illustrate where the roll trend cease and is reversed. In FIG. 8G, the forward velocity versus time is illustrated. In FIG. 8H, the lateral velocity exceeding the energy rate threshold is illustrated at Point c. The roll trend is illustrated best in FIG. 8F ceases and is reversed when the energy rate threshold is still exceeded as shown in FIG. 8H. Point C illustrates when the accumulative direction indicator Δω is initiated. Thus, as can be seen, even though the energy threshold is exceeded, the safety device is not deployed.

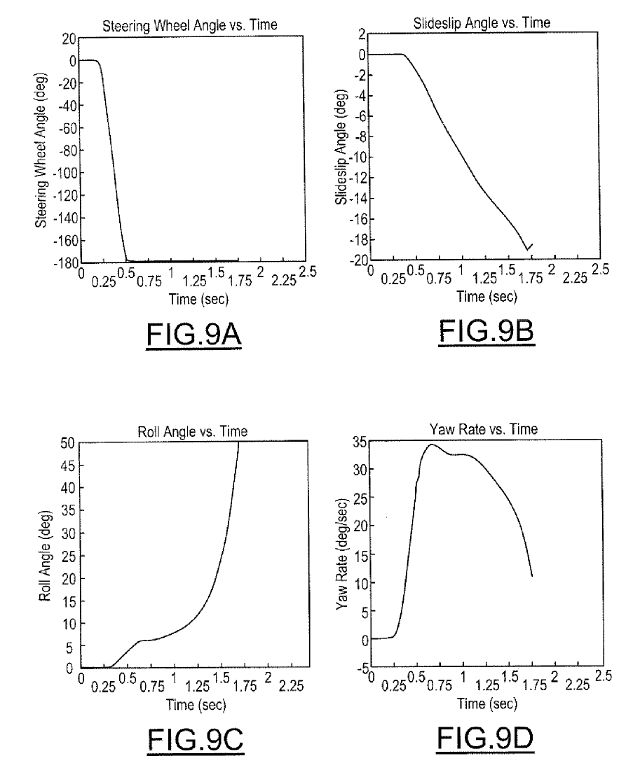

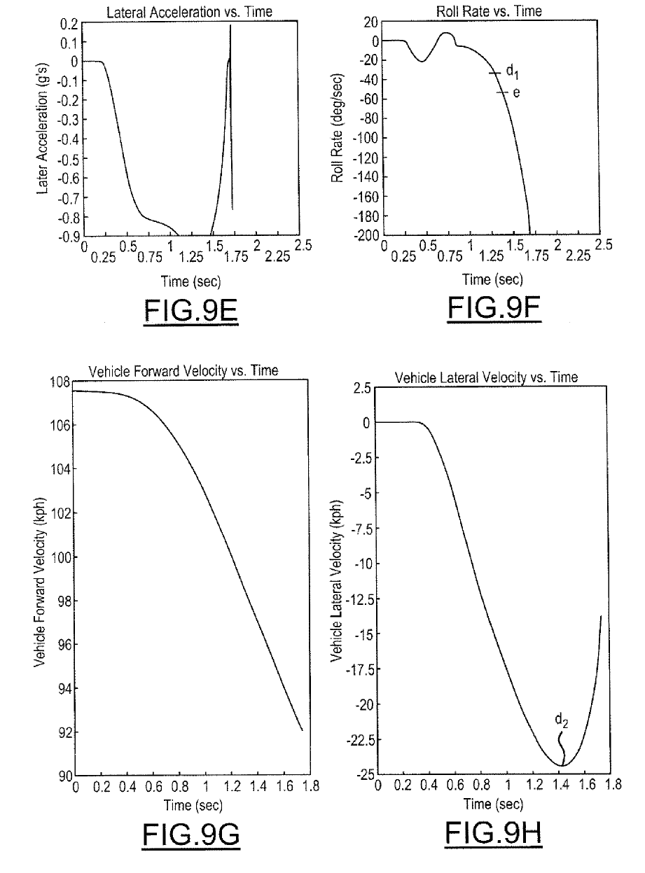

Referring now to FIGS. 9A-9H, a vehicle in a J-turn is illustrated. At Point d1, the accumulative directional indicator is initiated. That is, the energy rate threshold is exceeded at Point d1. As can be seen by the roll rate versus time plot, the roll trend continues and actually accelerates. At Point e a decision is made that the vehicle is rolling over and a safety device is deployed. Point d2 on the vehicle lateral velocity versus time plot of FIG. 9H illustrates this point.

Referring now to FIG. 10, a flow chart illustrating the operation of the present invention is illustrated. In step 140, the signals from the various sensors are read. In optional step 142, the dynamic control system is activated in response to the output of the various sensors. In step 144 the vehicle instability is determined. The vehicle instability may be determined by recognizing that the vehicle is unstable when the dynamic control system is activated in step 142. If step 142 and thus a dynamic control system is not present in the vehicle, the vehicle instability may be determined by exceeding of the energy and energy rate thresholds as described above in FIGS. 7A and 7B. If vehicle instability has been determined in step 144, step 146 is performed which determines whether a roll trend is being established. The roll trend may be calculated using the roll rate sensor of the vehicle. That is, the roll rate and the roll angle may be determined. More specifically, the change in the roll rate may be determined to indicate a roll trend. Various inputs may be provided in determining the accumulative direction indicator as described above. For example, vehicle speed, raw rate, slip angle, lateral acceleration and a steering wheel input may all be used to determine the roll trend of the vehicle.

In step 148 a roll trend has been indicated in step 146 and a safety device is activated. As mentioned above, various safety devices may be activated including a side curtain airbag, seatbelt pretensioners, external airbags, side impact airbags, and the like.

As is evident to those skilled in the art, the present invention allows a more accurate determination of the vehicle rolling over when vehicle instability is initially indicated. Therefore, unnecessary deployments of airbags when a correction of rollover may be provided by the vehicle is prevented.

While particular embodiments of the invention have been shown and described, numerous variations and alternate embodiments will occur to those skilled in the art. Accordingly, it is intended that the invention be limited only in terms of the appended claims.

What is claimed is:

1. A method of operating a vehicle having a safety device comprising:
generating a vehicle instability signal indicative of an unstable vehicle;
in response to the vehicle instability signal, generating an accumulative directional indicator; and
activating the safety device when the accumulative directional in indicator and the vehicle instability signal are indicative of a rollover condition.

2. A method as recited in claim 1 wherein generating a vehicle instability signal comprises comparing a vehicle lateral velocity and a threshold.

3. A method as recited in claim 1 wherein the threshold comprises an energy threshold.

4. A method as recited in claim 1 wherein generating a vehicle instability signal comprises generating the vehicle instability signal from a dynamic control system.

5. A method as recited in claim 1 wherein the dynamic control system comprises a roll stability control system.

6. A method as recited in claim 1 wherein the dynamic control system comprises a yaw stability control system.

7. A method as recited in claim 1 wherein generating a vehicle instability signal comprises generating the vehicle instability signal from an activation of a dynamic control system.

8. A method as recited in claim 7 wherein the dynamic control system comprises a roll stability control system.

9. A method as recited in claim 7 wherein the dynamic control system comprises a yaw stability control system.

10. A method as recited in claim 1 further comprising determining a yaw rate of the vehicle, and wherein activating comprises activating the safety device when the accumulative directional indicator is indicative of the rollover condition and when the yaw rate compared to a threshold is indicative of the rollover condition.

11. A method as recited in claim 1 further comprising determining a roll rate of the vehicle, and wherein activating comprises activating the safety device when the accumulative directional indicator is indicative of the rollover condition and when the roll rate is indicative of the rollover condition.

12. A method as recited in claim 1 wherein generating an accumulative directional indicator comprises determining the accumulative directional indicator in response to a change in roll rate.

13. A method as recited in claim 1 wherein generating an accumulative directional indicator comprises determining the accumulative directional indicator in response to a change in roll angle.

14. A method as recited in claim 1 wherein generating an accumulative directional indicator comprises determining the accumulative directional indicator in response to a change in roll rate and a change in roll angle.

15. A method as recited in claim 1 wherein generating an accumulative directional indicator comprises determining the accumulative directional indicator in response to a change in roll rate and a change in roll angle and a previous accumulated directional indicator.

16. A method as recited in claim 1 wherein generating an accumulative directional indicator comprises determining the accumulative directional indicator in response to a change in roll rate and a first gain and a change in roll angle and a second gain and a previous accumulated directional indicator.

17. A method as recited in claim 16 wherein the first gain and the second gain are determined as a function of at least one of a vehicle speed, a yaw rate, a slip angle, a lateral acceleration and a steering wheel input.

18. A method as recited in claim 1 wherein activating a safety device comprises activating an airbag.

19. A method as recited in claim 1 wherein activating a safety device comprises activating a side airbag.

20. A method as recited in claim 1 wherein activating a safety device comprises activating a side curtain airbag.

21. A method as recited in claim 1 wherein activating a safety device comprises activating a seatbelt pretensioner.

22. A method of operating a safety device comprising:
sensing a plurality of dynamic conditions of the vehicle including roll rate signal;
activating a dynamic control system in response to at least some of the plurality of dynamic conditions;
generating a dynamic control system status signal in response to activating;
after the step of generating a dynamic control system status signal, determining a rollover trend in response to the roll rate signal; and
activating the safety device when the roll trend is indicative of a rollover condition and the dynamic control system status signal.

23. A method as recited in claim 22 wherein sensing a plurality of dynamic conditions comprises determining at least one of a vehicle lateral velocity, a yaw rate, a roll rate.

24. A method as recited in claim 22 wherein the dynamic control system comprises a roll stability control system.

25. A method as recited in claim 22 wherein the dynamic control system comprises a yaw stability control system.

26. A method as recited in claim 22 wherein determining a rollover trend comprises determining the rollover trend in response to a change in roll rate.

27. A method as recited in claim 22 wherein determining a rollover trend comprises determining the rollover trend in response to a change in roll angle.

28. A method as recited in claim 22 wherein determining a rollover trend comprises determining the rollover trend in response to a change in roll rate and a change in roll angle.

29. A method as recited in claim 22 wherein determining a rollover trend comprises determining the rollover trend in response to a change in roll rate and a first gain and a change in roll angle and a second gain.

30. A method as recited in claim 29 wherein the first gain and the second gain are determined as a function of at least one of a vehicle speed, a yaw rate, a slip angle, a lateral acceleration and a steering wheel input.

31. A method as recited in claim 22 wherein activating a safety device comprises activating an airbag.

32. A method as recited in claim 22 wherein activating a safety device comprises activating a side airbag.

33. A method as recited in claim 22 wherein activating a safety device comprises activating a side curtain airbag.

34. A method as recited in claim 22 wherein activating a safety device comprises activating a seatbelt pretensioner.

35. A control system comprising:
a safety device;
a plurality of dynamic sensors generating dynamic sensor signals corresponding to dynamic conditions of the vehicle and including at least a roll rate sensor generating a roll rate signal;
a dynamic control system generating a dynamic control status system in response to the dynamic sensor signals; and
a controller coupled to the safety device, the plurality of dynamic sensors and the dynamic control system, said controller determining a rollover trend in response to the roll rate signal and activating the safety device in response to the roll trend being indicative of a rollover condition and in response to the dynamic control system status signal.

36. A method as recited in claim 35 wherein sensing a plurality of dynamic conditions comprises determining at least one of a vehicle lateral velocity, a yaw rate, a roll rate.

37. A control system as recited in claim 35 wherein the dynamic control system comprises at least one of a roll stability control system and a yaw stability control system.

38. A control system as recited in claim 35 wherein said controller determining a rollover trend comprises said controller determining the rollover trend in response to a change in roll rate or a change in roll angle.

39. A control system as recited in claim 35 wherein said controller determining a rollover trend comprises said controller determining the rollover trend in response to determining the rollover trend in response to a change in roll rate and a first gain and a change in roll angle and a second gain.

40. A control system as recited in claim 39 wherein the first gain and the second gain are a function of at least one of a vehicle speed, a yaw rate, a slip angle, a lateral acceleration and a steering wheel input.

41. A control system as recited in claim 35 wherein the safety device comprises at least one of an airbag, a side airbag, a side curtain airbag and a seatbelt pretensioner.
